(19) United States
(12) Patent Application Publication
(10) Pub. No.: US 2023/0058275 A1
(43) Pub. Date: Feb. 23, 2023

(54) HEATING COOKING APPARATUS

(71) Applicant: SHARP KABUSHIKI KAISHA, Sakai City, Osaka (JP)

(72) Inventor: TAKUSHI KISHIMOTO, Sakai City, Osaka (JP)

(21) Appl. No.: 17/790,700

(22) PCT Filed: Feb. 19, 2021
(86) PCT No.: PCT/JP2021/006255

§ 371 Date: Jul. 1, 2022

(30) Foreign Application Priority Data
Feb. 26, 2020 (JP) 2020-030770

(51) Int. Cl. H05B 6/64

(52) U.S. Cl. CPC H05B 6/6447

(57) ABSTRACT

To eliminate various problems caused by a no-load operation. A heating cooking apparatus of the present invention, which is a heating cooking apparatus (1) that performs heating cooking of a food product (40) in accordance with an information code read from the food product (40), includes a light receiving element (32) provided at a position where the light receiving element cannot receive light when the food product (40) is present in the heating chamber (13) but can receive the light when no food product (40) is present and perform no heating cooking when the light receiving element (32) can receive the light.

### TECHNICAL FIELD

The present invention relates to a heating cooking apparatus for heating a food product placed inside a heating chamber.

### BACKGROUND ART

For example, convenience stores have provided service to heat food products, such as boxed meals bought by customers, in a heating cooking apparatus, such as a microwave oven, and then hand the food products to the customers.

A suitable heating temperature and heating time in heating a food product depend on the type of food product. Then, in the heating cooking apparatuses described in PTL 1 and PTL 2, a barcode that is printed on a container of a food product and indicates the type of food product is read by a reading device, and the food product is heated in accordance with heating information (heating temperature and heating time) corresponding to the type of food product.

Specifically, in a configuration described in PTL 1, a barcode scanner is connected to a microwave oven, and a user manually operates the barcode scanner to read a barcode printed on a container of a food product.

In a configuration described in PTL 2, a barcode is read by passing the barcode printed on a container of a food product over a first barcode reader provided on one side portion of the front face of a heating cooking apparatus. Alternatively, the food product contained in the container is placed inside a heating chamber of the heating cooking apparatus, and the barcode printed on the container of the food product is read by a second barcode reader provided on the top wall of the heating chamber.

### CITATION LIST

### Patent Literature

PTL 1: JP 2006-64362 A

PTL 2: JP 3076649 UM-B

### SUMMARY OF INVENTION

### Technical Problem

Incidentally, neither PTL 1 nor PTL 2 describes timings when a barcode scanner or a first or second barcode reader performs reading. Unfortunately, a configuration in which these reading devices constantly reads could lead to erroneously reading a barcode on a container of a heated food product when taken out from the inside of a heating chamber. In this case, the food product has already been taken out from the heating chamber, and thus heating is to be performed without food in the heating chamber. That is, a no-load operation is performed, and a burden is imposed on a heating unit of the heating cooking apparatus, for example, a magnetron, shortening the life of the apparatus.

One aspect of the present invention is to provide a heating cooking apparatus that prevents various problems due to a no-load operation by eliminating the no-load operation.

### Solution to Problem

To solve the above-described problem, a heating cooking apparatus according to an aspect of the present invention includes a heating chamber, a reading device configured to read an information code indicating at least a type of food product, a heating control unit configured to perform heating control of the food product disposed in the heating chamber in accordance with heating information that is necessary for heating cooking and included in the information code read by the reading device, and a determination unit configured to determine whether a food product is disposed in the heating chamber, in which the heating control unit does not perform the heating control when the determination unit determines that no food product is disposed in the heating chamber.

### Advantageous Effects of Invention

An aspect of the present invention allows for preventing various problems due to a no-load operation.

### BRIEF DESCRIPTION OF DRAWINGS

FIG. 1 is a perspective view of a heating cooking apparatus of an embodiment of the present invention with a front door thereof closed when viewed from an obliquely upper front side.

FIG. 2 is a front view of the heating cooking apparatus illustrated in FIG. 1 with the front door thereof opened.

FIG. 3 is a perspective view of the heating cooking apparatus illustrated in FIG. 1 with the front door thereof opened when viewed from an obliquely lower right side.

FIG. 4 is a vertical sectional view of a control frame illustrating an installation state of a reading device included in the heating cooking apparatus illustrated in FIG. 1.

FIG. 5 is an explanatory diagram illustrating a reading region of the reading device illustrated in FIG. 4.

(a) of FIG. 6 is an explanatory diagram illustrating an example of an information code constituted of a two-dimensional code to be read by the reading device illustrated in FIG. 4, and (b) of FIG. 6 is an explanatory diagram illustrating an example of an information code constituted of a one-dimensional barcode to be read by the reading device illustrated in FIG. 4.

FIG. 7 is a schematic view schematically illustrating the heating cooking apparatus illustrated in FIG. 1.

FIG. 8 is a block diagram illustrating a configuration of a control device included in the heating cooking apparatus illustrated in FIG. 1.

FIG. 9 is a schematic view schematically illustrating a heating cooking apparatus according to another embodiment of the present invention.

FIG. 10 is a schematic view schematically illustrating a heating cooking apparatus according to still another embodiment of the present invention.

### DESCRIPTION OF EMBODIMENTS

### First Embodiment

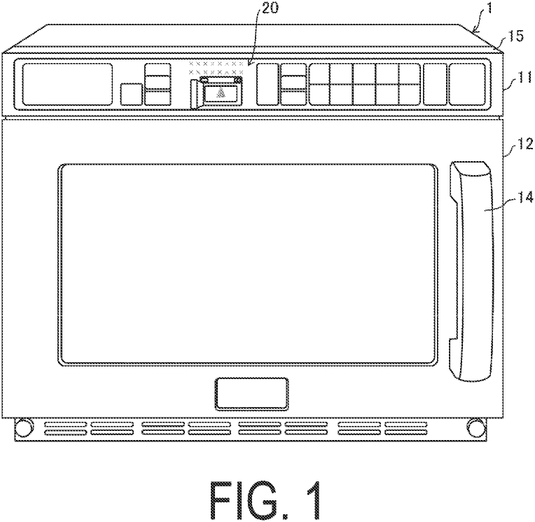

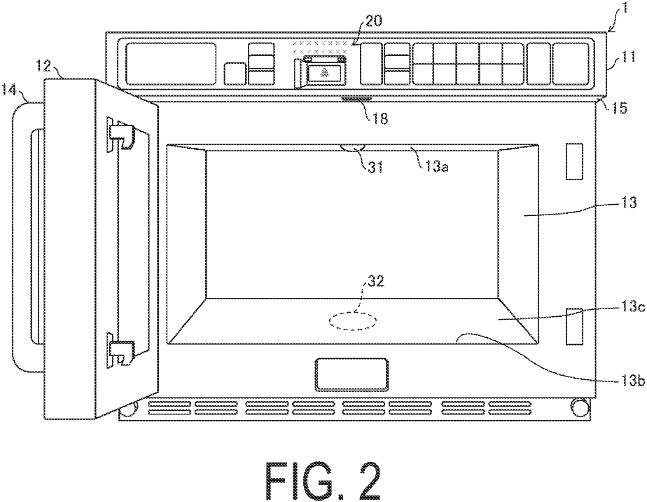

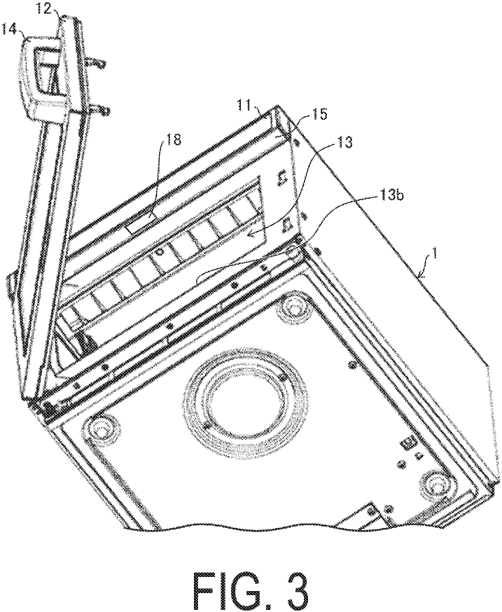

An embodiment of the present invention will be described in detail below. FIG. 1 is a perspective view of a heating cooking apparatus 1 of the present embodiment with a front door 12 thereof closed when viewed from an obliquely upper front side. FIG. 2 is a perspective view of the heating cooking apparatus 1 illustrated in FIG. 1 with the front door 12 thereof opened when viewed from an obliquely lower front side. FIG. 3 is a perspective view of the heating cooking apparatus 1 illustrated in FIG. 1 with the front door 12 thereof opened when viewed from an obliquely lower right side.

### Outline of Heating Cooking Apparatus 1

As illustrated in FIG. 1 to FIG. 3, the heating cooking apparatus is, for example, a microwave oven, and includes an operation panel (reception unit) 11 on an upper side of a front face and a front door 12 under the operation panel 11. The front door 12 is a door configured to open and close a heating chamber 13 provided behind the front door 12 and covers a front face opening 13b of the heating chamber 13 in a closed state. In the present embodiment, the front door 12 is a horizontal opening door that rotates about an end portion on the left side when viewed from the front and has a handle 14 near a right end thereof.

As illustrated in FIG. 2, in the heating chamber 13, a light emitting element 31 is provided on a top surface 13a, and a light receiving element 32 that receives light emitted by the light emitting element 31 is provided below a flat plate 13c on a bottom face. The flat plate 13c is formed of a light-transmissive material, enabling the light receiving element 32 provided below the flat plate 13c to receive light emitted by the light emitting element 31. In this manner, the presence or absence of a food product to be placed in the heating chamber 13 is detected using the light emitting element 31 and the light receiving element 32. Details of determination of the presence or absence of a food product in the heating chamber 13 will be described later.

The operation panel 11 is provided on the front face of a control frame (circuit board container portion) 15, and the front face position of the operation panel 11 is substantially coincident with the front face position of the front door 12 in a front-rear direction of the heating cooking apparatus 1.

A control substrate (not illustrated) that controls a display unit of the operation panel 11, receives user operations with respect to, for example, input keys, or the like is provided inside the control frame 15.

### Reading Device 16

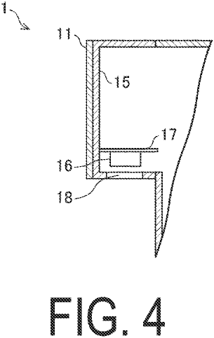

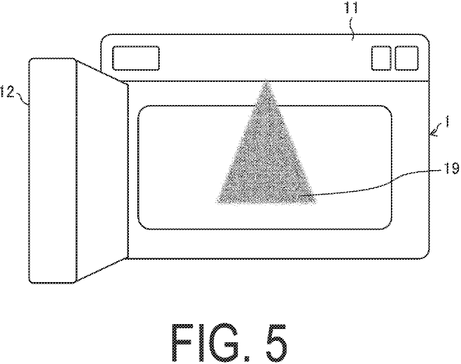

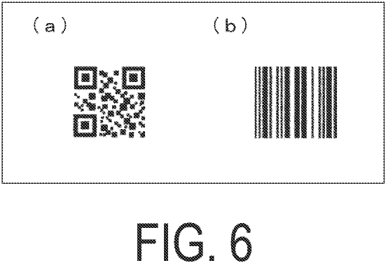

FIG. 4 is a vertical sectional view of the control frame 15 illustrating the installation state of the reading device 16. FIG. 5 is an explanatory diagram illustrating a reading region 19 of the reading device 16.

As illustrated in FIG. 4, the control frame 15 is provided projecting forward from the heating cooking apparatus 1. The reading device 16 is attached to a lower face of a reading device substrate (circuit substrate) 17 and is provided in a lower portion inside the control frame 15. The reading device substrate 17 is provided with a drive circuit of the reading device 16. In other words, the reading device 16 is at an installation position outside the heating chamber 13 and above the front face opening 13b of the heating chamber 13 (a position on the top surface 13a side) and is provided to have the reading region 19 below the installation position.

The reading device 16 is, for example, a barcode reader, and is configured to read an information code (for example, a barcode) provided on a food product to be heated by the heating cooking apparatus 1 or a container of a food product.

As illustrated in FIG. 5, the reading device 16 takes a region below the reading device 16 as the reading region 19, and the control frame 15 has a transparent reading window 18 in a portion of a lower wall portion thereof facing the reading device 16.

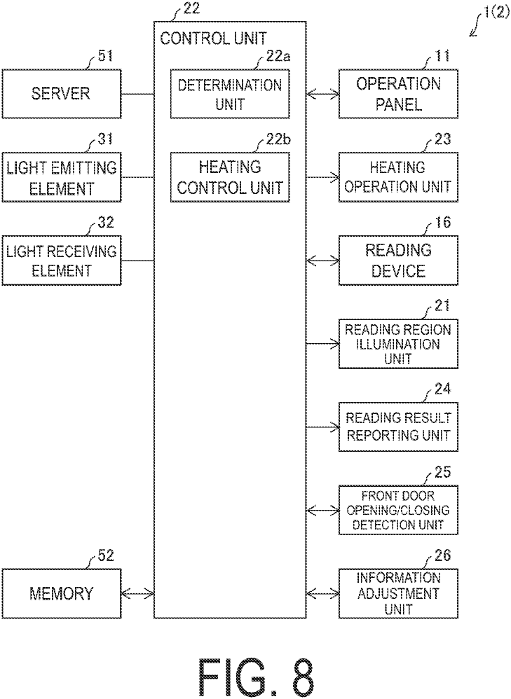

The reading region 19 of the reading device 16 is indicated by, for example, red light so that a user can visually recognize the reading region 19. The red light is emitted by a reading region illumination unit 21 (see FIG. 8). A red LED, for example, is used as the reading region illumination unit 21. Note that light indicating the reading region 19 is not limited to red light but may be other light visible to the user, such as a laser. In addition, the number of red LEDs may be one or may be more than one.

In addition, as illustrated in FIG. 2 and FIG. 3, the reading device 16 is provided in a center portion in a width direction (right-left direction) of the front face opening 13b of the heating chamber 13.

### Information Code

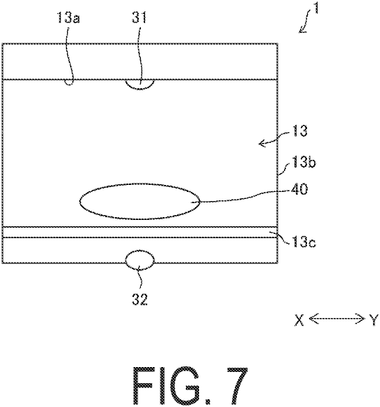

(a) of FIG. 6 is an explanatory diagram illustrating an example of an information code constituted of a two-dimensional code (QR code (trademark)), and (b) of FIG. 6 is an explanatory diagram illustrating an example of an information code constituted by a one-dimensional barcode. (a) of FIG. 7 is an explanatory diagram illustrating an example of a guide display in the operation panel 11 for reading the information code by the reading device 16, and (b) of FIG. 7 is an explanatory diagram illustrating another example of the guide display in the operation panel 11 for reading the information code by the reading device 16.

The information code is information indicating the type of food product and is provided on the food product or the container of the food product by, for example, printing or applying a seal. The information code is information indicating the type of food product, for example, indicating that the food product is a boxed meal (or further indicating the type of boxed meal) or indicating that the food product is a rice ball (or further indicating the type of rice ball).

The information code may be, for example, a two-dimensional code as illustrated in (a) of FIG. 6, or may be a one-dimensional barcode as illustrated in (b) of FIG. 6. Note that the information code is not particularly limited to a barcode or the like as long as the information code can indicate the type of food product.

Determination of Presence or Absence of Food Product in Heating Chamber 13 FIG. 7 is a schematic view schematically illustrating the heating cooking apparatus 1 illustrated in FIG. 1. In FIG. 7, the front face opening 13b of the heating chamber 13 is illustrated on the right side, and it is assumed that a food product 40 is taken into and out from the right side in the drawing. Here, an arrow X direction is a direction in which the food product 40 is taken into the heating chamber 13, and an arrow Y direction is a direction in which the food product 40 is taken out from the heating chamber 13.

As illustrated in FIG. 7, in a state where the food product 40 is disposed in the heating chamber 13, light emitted from the light emitting element 31 is blocked by the food product 40 and is not received by the light receiving element 32. That is, in a state where the food product 40 is disposed in the heating chamber 13, a signal indicating that light is not being received from the light receiving element 32 is transmitted to a control unit 22 to be described below.

On the other hand, as illustrated in FIG. 7, when the food product 40 disposed in the heating chamber 13 is taken out from the front face opening 13b in the arrow Y direction, light emitted from the light emitting element 31 is received by the light receiving element 32. Thus, a signal (light reception signal) indicating that light is being received from the light receiving element 32 is transmitted to the control unit 22 to be described below.

As described above, the control unit 22 determines whether the food product 40 is disposed in the heating chamber 13 in response to the signal from the light receiving element 32. That is, using the light emitting element 31 and the light receiving element 32 allow for determining whether the food product 40 is disposed in the heating chamber 13. Details of determination of whether the food product 40 is disposed in the heating chamber 13 will be described later.

### Control Device

FIG. 8 is a block diagram illustrating a configuration of a control device included in the heating cooking apparatus 1. The control device includes the control unit 22 controlling operations of the heating cooking apparatus 1. The control unit 22 is constituted of, for example, a microcomputer, and includes a CPU, a ROM, and a RAM.

As illustrated in FIG. 8, the operation panel 11, a heating operation unit 23, the reading device 16, the reading region illumination unit 21, a reading result reporting unit 24, a front door opening/closing detection unit 25, an information adjustment unit 26, and a memory (storage unit) 32 are connected to the control unit 22. The front door opening/closing detection unit 25 is constituted of, for example, a switch that is turned on when the front door 12 is closed, and detects an opened state and a closed state of the front door 12.

The heating operation unit 23 is an operation unit configured to heat a food product disposed in the heating chamber 13 and is, for example, a microwave output device or a heater. The reading result reporting unit 24 is a buzzer or a voice generator and is controlled by the control unit 22 to notify a user of success or failure in reading an information code by the reading device 16.

The control unit 22 is able to communicate with a server 51 by using, for example, an Internet line. Heating information corresponding to various types of food products is registered in the server 51. The control unit 22 acquires, from the server 51, heating information that corresponds to the type of food product and is acquired by the reading device 16 reading the information code and controls the heating operation unit 23 to heat the food product in accordance with the acquired heating information. Note that the heating information corresponding to the type of food product may be included in the heating cooking apparatus 1 itself. In this case, the heating cooking apparatus 1 does not need to communicate with the server 51.

In addition, the control unit 22 controls operations of the reading result reporting unit 24 and notifies a user of success or failure in reading the information code by the reading device 16.

Further, the control unit 22 includes a determination unit 22a that determines whether the food product 40 is present in the heating chamber 13 and a heating control unit 22b that controls heating operations of the heating operation unit 23 in accordance with a determination result of the determination unit 22a.

The determination unit 22a determines whether the food product 40 is present in the heating chamber 13 in response to a signal from the light receiving element 32. Here, the determination unit 22a determines that no food product 40 is disposed in the heating chamber 13 when receiving a signal indicating that light has been received from the light receiving element 32 and determines that the food product 40 is disposed in the heating chamber 13 when receiving a signal indicating that light is not being received from the light receiving element 32.

The heating control unit 22b permits a heating operation performed by the heating operation unit 23 when the determination result of the determination unit 22a is a result indicating that the food product 40 is present in the heating chamber 13, whereas the heating control unit 22b does not permit a heating operation performed by the heating operation unit 23 when the determination result of the determination unit 22a is a result indicating that no food product 40 is present in the heating chamber 13.

The information adjustment unit 26 adjusts heating information required for heating cooking included in the information code read by the reading device 16 in accordance with change information set for each food product. The heating information means a heating time and wattage of a high-frequency output in the heating cooking apparatus 1. The change information is information for changing default heating information for setting to a desired heating temperature (a heating time, wattage), and is information for changing a heating temperature in the case of heating according to the default heating information to “hot” or “lukewarm.” The information for changing a heating temperature to “hot” or “lukewarm” is set by operating a button of “hot” or “lukewarm” of heating change buttons 11a provided in the operation panel 11 described above.

The change information may be included in the information code, may be stored in association with each food product in the memory 52, or may be stored in the server 51 via a network such as the Internet.

In addition, heating information included in the information code read by the reading device 16 is stored in the memory 52. Thereby, heating information is registered in the memory 52 of the heating cooking apparatus 1 for a food product for which an information code has been read once, and thus it is not necessary to acquire heating information every time an information code is read from the outside of the heating cooking apparatus 1. Thus, when a food product specified by the information code read by the reading device 16 is stored in the memory 52, the information adjustment unit 26 reads the heating information associated with the food product and adjusts the heating information based on the change information.

### Operation of Heating Cooking Apparatus 1

Operations of the heating cooking apparatus 1 in the above-described configuration will be described below. Here, a case where the food product 40 is set to be a boxed meal with an information code applied onto the upper face of a container thereof and is heated by the heating cooking apparatus 1 will be described.

First, a user confirms a guide display 20 (for example, “please open the door and pass the information code over the red light”) of the operation panel 11. Then, the user opens the front door 12 in accordance with the guide display 20. When the front door opening/closing detection unit 25 detects the opened state of the front door 12, the control unit 22 causes the reading device 16 and the reading region illumination unit 21 to operate.

Next, the user moves a boxed meal so that the information code enters the reading region 19 of the reading device 16 (so that the red light strikes the information code) in accordance with the guide display 20 of the operation panel 11.

This operation causes the reading device 16 to read the information code applied to the boxed meal. When the reading device 16 successfully reads the information code, the control unit 22 causes the reading result reporting unit 24 to report the reading result to the user. The operation of the reading result reporting unit 24 in this case is, for example, an operation of emitting a continuous beep sound, a voice operation output saying “the information code is read successfully,” or an operation including both the above operations.

When informed of the success of reading the information code by the reading result reporting unit 24, the user places the boxed meal in the heating chamber 13, then closes the front door 12, and presses the start button on the operation panel 11. In this state, as illustrated in FIG. 7, the boxed meal to be heated is disposed at a predetermined position within the heating chamber 13. That is, the boxed meal is disposed at a position where the light receiving element 32 cannot receive light from the light emitting element 31 in the heating chamber 13. At this time, in the control unit 22, the determination unit 22a determines that the food product 40 is disposed in the heating chamber 13, and a heating control performed by the heating control unit 22b, that is, a heating operation performed by the heating operation unit 23 is permitted in accordance with the determination result.

Further, in a case where the user prefers either “lukewarm” or “hot,” the user operates any one of the heating change buttons 11a of the operation panel 11 before pressing a start button on the operation panel 11.

When the information code has been successfully read, the control unit 22 communicates with the server 51 to acquire heating information corresponding to the type of food product indicated by the information code from the server 51. Thereafter, when the user closes the front door 12 and presses the start button on the operation panel 11, the control unit 22 heats the boxed meal in the heating chamber 13 in accordance with the acquired heating information.

Further, in a case where the user prefers either “lukewarm” or “hot,” the control unit 22 communicates with the server 51 to acquire heating information corresponding to the type of food product indicated by the information code from the server 51 when the information code has been successfully read. Thereafter, in the control unit 22, the user closes the front door 12, operates the heating change buttons 11a of the operation panel 11, and presses the start button. After the pressing of the start button, the acquired heating information is adjusted in accordance with the change information (lukewarm or hot) set for each food product, and the boxed meal in the heating chamber 13 is heated according to the adjusted heating information.

Here, the setting of “lukewarm” or “hot” is used for adjusting the heating time while leaving the wattage unchanged. The setting of “lukewarm” or “hot” varies depending on a food product, and the heating time is changed to 0.9 times in the case of “lukewarm” and is changed to 1.1 times in the case of “hot” with, for example, a default heating time as a reference. Thus, the change information in this case is scaling information for a reference heating time.

On the other hand, when the reading of the information code by the reading device 16 has failed, the control unit 22 causes the reading result reporting unit 24 to report the reading result to the user. The operation of the reading result reporting unit 24 in this case is, for example, an operation of emitting an intermittent sound of “bleep, bleep, bleep,” an operation of outputting a voice saying “the information code was not read correctly,” or an operation including both the above operations.

When the user is informed of the failure of reading the information code by the reading result reporting unit 24, the user moves the boxed meal again so that the information code enters the reading region 19 of the reading device 16 (so that the red light strikes the information code). After that, an operation to be taken when the information code is successfully read is as described earlier.

As described above, when the heating of the boxed meal is completed, the user is notified of the completion of the heating, and the user takes the boxed meal out from the heating chamber 13. Light emitted from the light emitting element 31 is received by the light receiving element 32 by taking the boxed meal out from the heating chamber 13, and the determination unit 22a of the control unit 22 determines that no boxed meal is present in the heating chamber 13. The heating control unit 22b does not permit a heating operation performed by the heating operation unit 23 in accordance with a determination result of the determination unit 22a (no boxed meal is disposed in the heating chamber 13). Accordingly, no heating operation is performed by the heating operation unit 23 in a state where no boxed meal is disposed in the heating chamber 13. That is, no heating operation is performed in a no-load state. For example, even when the reading device 16 reads the information code again while the boxed meal is being taken out and successfully reads the information code, no heating operation is performed, because no boxed meal is disposed in the heating chamber 13.

### Effects

The heating cooking apparatus 1 having the above-described configuration determines whether the food product 40 is disposed in the heating chamber 13, and when a determination result indicates that no food product 40 is disposed in the heating chamber 13, a heating operation performed by the heating operation unit 23 is not permitted. Accordingly, a heating operation performed by the heating operation unit 23 in a state where no object to be heated is present in the heating chamber 13, that is, in a no-load state (no-load operation) is not permitted, and thus a problem caused by the no-load operation does not occur. For example, there is no problem that a burden is imposed on the magnetron due to a no-load operation, and the life of the apparatus is shortened.

That is, compared to a case where the temperature of the magnetron is detected after heating control is performed once to determine that it is a no-load operation as in the related art, no burden is imposed on the apparatus, and thus the life of the apparatus can be extended.

Note that, in the present embodiment, the light emitting element 31 is provided for detection of the food product 40, but when light emitted by the light emitting element 31 is visible light, a chamber inside lamp (not illustrated) already provided in the heating chamber 13 may be used instead of providing the light emitting element 31. In this case, when the food product 40 is disposed in the heating chamber 13, the light receiving element 32 may be disposed at a position where light of the chamber inside lamp is blocked. In this manner, an existing chamber inside lamp can be used as long as light emitted by the light emitting element 31 is visible light.

However, the light emitted by the light emitting element 31 may be infrared light. In this case, light received by the light receiving element 32 also needs to be infrared light. In this manner, in a case where the presence or absence of the food product 40 in the heating chamber 13 is determined using infrared light, there is less susceptibility to noise such as external light as compared with a case where visible light is used.

Further, in the present embodiment, an example in which one light receiving element 32 is used has been described, but an example two light receiving elements 32 are used will be described in the following embodiments.

### Second Embodiment

Another embodiment of the present invention will be described below. Note that, for convenience of description, components having the same functions as those described in the above-described embodiment will be denoted by the same reference signs, and descriptions of those components will be omitted.

### Heating Cooking Apparatus 2

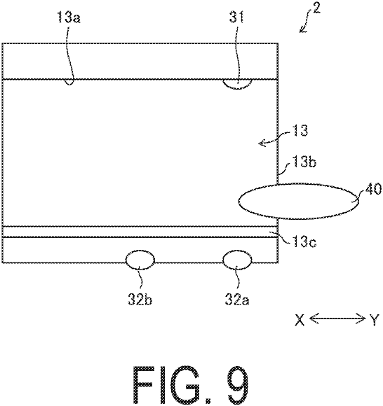

FIG. 9 is a schematic view schematically illustrating a heating cooking apparatus 2 according to the present embodiment. Also in FIG. 9, similarly to FIG. 7 in the above-described first embodiment, a front face opening 13b of a heating chamber 13 is illustrated on the right side, and it is assumed that a food product 40 is taken into and out from the right side in the drawing. Here, an arrow X direction is a direction in which the food product 40 is taken into the heating chamber 13, and an arrow Y direction is a direction in which the food product 40 is taken out from the heating chamber 13.

The heating cooking apparatus 2 illustrated in FIG. 9 is different from the heating cooking apparatus 1 illustrated in FIG. 7 in the first embodiment in that two light receiving elements (a first receiving element 32a and a second light receiving element 32b) are provided, but the other configurations are the same.

The first light receiving element 32a is disposed below a flat plate 13c and in the vicinity of the front face opening 13b, and the second light receiving element 32b is disposed below the flat plate 13c and on a side closer to the center of the heating chamber 13 than the first light receiving element 32a.

The light emitting element 31 is only required to be provided at a position where both the first light receiving element 32a and the second light receiving element 32b can receive light. FIG. 9 illustrates an example in which the light emitting element 31 is provided on a top surface 13a from the front face opening 13b.

### Determination of Presence or Absence of Food Product in Heating Chamber 13

In the heating cooking apparatus 2 illustrated in FIG. 9, when the food product 40 is taken into the heating chamber 13 from the front face opening 13b, first, a state is set in which where light emitted from the light emitting element 31 is temporarily blocked by the food product 40, and the first light receiving element 32a cannot receive light. Further, when the food product 40 is taken into the heating chamber 13, a state is set in which light emitted from the light emitting element 31 is temporarily blocked by the food product 40, and the second light receiving element 32b cannot receive light. In a state where the food product 40 is disposed at a predetermined position in the heating chamber 13, a state is only required to be set in which at least the second light receiving element 32b cannot receive light. That is, in a state where the food product 40 is disposed at a predetermined position in the heating chamber 13, a state is only required to be set in which the second light receiving element 32b cannot receive light and the first light receiving element 32a can receive light.

Next, when the food product 40 in the heating chamber 13 is taken out, first, a state where the second light receiving element 32b can receive light is set, and the second light receiving element 32b receives light emitted from the light emitting element 31. Further, when the food product 40 is moved toward the front face opening 13b so as to be taken out from the heating chamber 13, a state where the first light receiving element 32a can receive light is set, and the first light receiving element 32a receives light emitted from the light emitting element 31.

The determination unit 22a of the control unit 22 first receives a light reception signal from the second light receiving element 32b, and then receives a signal indicating that light has been received from the first light receiving element 32a to determine that the food product 40 has been taken out from the heating chamber 13, that is, determine that no food product 40 is disposed in the heating chamber 13. Here, to determine that the food product 40 has been certainly taken out from the heating chamber 13, the disposition of the first light receiving element 32a is preferably set to the front face opening 13b side as much as possible.

As described above, the control unit 22 determines whether the food product 40 is disposed in the heating chamber 13 according to the presence or absence of a signal indicating that light has been received from two light receiving elements (the first light receiving element 32a and the second light receiving element 32b). That is, it is possible to detect the food product 40 in the heating chamber 13 by using the light emitting element 31, the first light receiving element 32a, and the second light receiving element 32b.

In the first and second embodiments, when no food product 40 is disposed in the heating chamber 13, the light receiving element 32 (the first light receiving element 32a, the second light receiving element 32b) is disposed below the flat plate 13c on a side facing the light emitting element 31 of the top surface 13a. However, no such limitation is intended, and the light emitting element 31 may be provided on the side surface of the heating chamber 13, or the light receiving element 32 (the first light receiving element 32a and the second light receiving element 32b) may be provided on the side surface. In short, the light emitting element 31 and the light receiving element 32 (the first light receiving element 32a, the second light receiving element 32b) may be disposed at a position where light received by the light receiving element 32 (the first light receiving element 32a and the second light receiving element 32b) is blocked by the disposed food product 40, the light being emitted by the light emitting element 31.

Further, the light receiving element 32 may be disposed on the top surface 13a on the same side as the light emitting element 31. This example will be described below in a third embodiment.

### Third Embodiment

Another embodiment of the present invention will be described below. Note that, for convenience of description, components having the same functions as those described in the above-described embodiment will be denoted by the same reference signs, and descriptions of those components will be omitted.

### Heating Cooking Apparatus 3

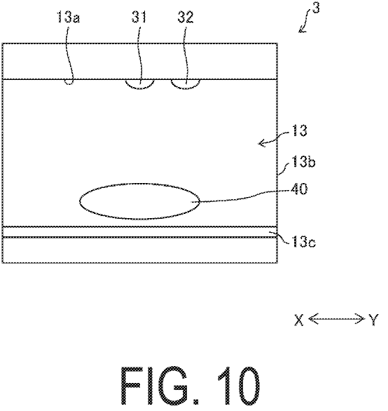

FIG. 10 is a schematic view schematically illustrating a heating cooking apparatus 3 according to the present embodiment. Also in FIG. 10, similarly to FIG. 7 in the above-described first embodiment, a front face opening 13b of a heating chamber 13 is illustrated on the right side, and it is assumed that a food product 40 is taken into and out from the right side in the drawing. Here, an arrow X direction is a direction in which the food product 40 is taken into the heating chamber 13, and an arrow Y direction is a direction in which the food product 40 is taken out from the heating chamber 13.

The heating cooking apparatus 3 illustrated in FIG. 10 differs from the heating cooking apparatus 1 of the first embodiment illustrated in FIG. 7 in that a light emitting element 31 and a light receiving element 32 are disposed on a top surface 13a of the heating chamber 13, but the other configurations are the same.

Here, in the heating cooking apparatus 3, the light receiving element 32 is disposed at a position where the light receiving element 32 can receive light emitted by the light emitting element 31 which strikes and reflects on the flat plate 13c or the food product 40 disposed on the flat plate 13c.

That is, the presence or absence of the food product 40 in the heating chamber 13 is determined using a difference between a light reception intensity of the light receiving element 32 when the food product 40 is disposed on the flat plate 13c and a light reception intensity of the light receiving element 32 when no food product 40 is disposed.

Here, the flat plate 13c having a material that transmits light causes, when no food product 40 is disposed on the flat plate 13c, light emitted from the light emitting element 31 to pass through the flat plate 13c, weakening a light reception intensity of reflected light received by the light receiving element 32. On the other hand, when the food product 40 is disposed on the flat plate 13c, light emitted from the light emitting element 31 strikes, and reflects on the food product 40, and is received by the light receiving element 32. The light reception intensity of the light receiving element 32 at this time is greater than the light reception intensity of the light receiving element 32 when the food product 40 is disposed on the flat plate 13c.

Thus, the determination unit 22a of the control unit 22 determines that the food product 40 is present in the heating chamber 13 when the light reception intensity of the light receiving element 32 is greater than a reference value (first light reception intensity) with the light reception intensity of the light receiving element 32 when the food product 40 is disposed on the flat plate 13c as the reference value.

### Determination of Presence or Absence of Food Product in Heating Chamber 13

In the heating cooking apparatus 3 illustrated in FIG. 10, when the food product 40 is taken into the heating chamber 13 from the front face opening 13b, a light reception intensity of the light receiving element 32 becomes greater than the reference value, and when the food product 40 is taken out from the front face opening 13b, the light reception intensity of the light receiving element 32 returns to the reference value.

As described above, the control unit 22 determines whether the food product 40 is disposed in the heating chamber 13 in accordance with the light reception intensity of the light receiving element 32.

Here, to accurately determine the presence or absence of the food product 40 in the heating chamber 13, a color change of light received by the light receiving element 32 is thought to be detected. For example, the light emitting element 31 emits RGB light as single colors, and the light receiving element 32 detects the presence or absence of the food product 40 from a change in the light reception intensity of each of the RGB light.

Note that, in the present embodiment, an example in which the light emitting element 31 and the light receiving element 32 are provided on the top surface 13a of the heating chamber 13 is described. However, no such limitation is intended, and the light emitting element 31 and the light receiving element 32 may be disposed below the flat plate 13c of the heating chamber 13. In this case, a hole is provided at a position facing a light emitting portion of the light emitting element 31 of the flat plate 13c and a position facing a light receiving portion of the light receiving element 32 so that the light emitting element 31 and the light receiving element 32 are not affected by microwaves generated when the heating cooking apparatus 3 performs heating.

### Example of Implementation by Software

A control block (in particular, the determination unit 22a, the heating control unit 22b) of the control unit 22 may be implemented by a logic circuit (hardware) constituted of an integrated circuit (IC chip) and the like, or may be implemented by software.

In the latter case, the control unit 22 includes a computer that executes a command of a program that is software for implementing functions. The computer includes at least one processor (control device), for example, and includes at least one computer-readable recording medium having stored the program therein. In the computer, the processor reads out the program from the recording medium and executes the program, thereby accomplishing the object of the present invention. For example, a Central Processing Unit (CPU) may be used as the processor. As the recording medium, a “non-transitory tangible medium” such as a tape, a disk, a card, a semiconductor memory, a programmable logic circuit and the like may be used in addition to a Read Only Memory (ROM) and the like. Additionally, a Random Access Memory (RAM) on which the program is loaded, or the like may be further provided. Further, the program may be supplied to the computer via any transmission medium (communication network, broadcast wave, or the like) capable of transmitting the program. Note that an aspect of the present invention may be implemented in a form of data signal embedded in a carrier wave, which is embodied by electronic transmission of the program.

### Supplement

A heating cooking apparatus according to a first aspect of the present invention includes a heating chamber (13), a reading device (16) configured to read an information code indicating at least a type of food product (40), a heating control unit (22b) configured to perform heating control of the food product (40) disposed in the heating chamber (13) in accordance with heating information that is necessary for heating cooking and included in the information code read by the reading device (16), and a determination unit (22a) configured to determine whether a food product is disposed in the heating chamber (13). The heating control unit (22b) does not perform the heating control when the determination unit (22a) determines that no food product (40) is disposed in the heating chamber (13).

According to the above-described configuration, even when the reading device reads the information code at the time of taking the food product out from the heating chamber, no heating control is performed when no food product is disposed in the heating chamber. That is, no no-load operation in the heating cooking apparatus is performed. Thus, various problems caused by a no-load operation, for example, a problem that a burden is imposed on a heating unit of the heating cooking apparatus, for example, a magnetron, and thus the life of the apparatus is shortened does not occur.

A heating cooking apparatus according to a second aspect of the present invention according to the first aspect the first aspect includes a light receiving element (32) provided at a position in the heating chamber (13) where light is blocked when the food product (40) is disposed. The determination unit (22a) may determine that no food product (40) is disposed in the heating chamber (13) when a signal indicating that light is received from the light receiving element (32) is received, and may determine that the food product (40) is disposed in the heating chamber (13) when a signal indicating that the light is not received from the light receiving element (32) is received.

According to the above-described configuration, it is possible to determine whether the food product is disposed in the heating chamber in accordance with whether the light receiving element has received light, ensuring that no no-load operation is performed. That is, compared to a case where the temperature of the magnetron is detected after heating control is performed once to determine that it is a no-load operation as in the related art, no burden is imposed on the apparatus, and thus the life of the apparatus can be extended.

A heating cooking apparatus according to a third aspect of the present invention according to the second aspect includes a plurality of the light receiving elements (32) in the heating chamber (13). The determination unit (22a) may determine that no food product (40) is disposed in the heating chamber (13) by receiving a signal indicating that beams of light from all of the plurality of the light receiving elements (32) are received.

According to the above-described configuration, it is possible to more accurately determine the presence or absence of the food product disposed in the heating chamber.

A heating cooking apparatus according to a fourth aspect of the present invention according to the first aspect includes a light receiving element (32) that is provided in the heating chamber (13) and configured to receive light reflected from the food product (40) when the food product (40) is disposed. The determination unit (22a) may determine that the food product (40) is disposed in the heating chamber (13) when a light reception intensity of light reflected from the light receiving element (32) exceeds a first light reception intensity (reference value) set in advance, and may determine that no food product (40) is disposed in the heating chamber (13) when the light reception intensity of the light reflected from the light receiving element (32) is equal to or less than the first light reception intensity (reference value).

According to the above-described configuration, it is possible to determine whether the food product is disposed in the heating chamber in accordance with a light reception intensity of the light receiving element, ensuring that no no-load operation is performed. That is, compared to a case where the temperature of the magnetron is detected after heating control is performed once to determine that it is a no-load operation as in the related art, no burden is imposed on the apparatus, and thus the life of the apparatus can be extended.

A heating cooking apparatus according to a fifth aspect of the present invention according to the fourth aspect includes a plurality of the light receiving elements (32) in the heating chamber (13). The determination unit (22a) may determine that no food product (40) is disposed in the heating chamber (13) when light reception intensities of beams of light reflected from all of the light receiving elements (32) are equal to or less than the first light reception intensity (reference value).

According to the above-described configuration, it is possible to more accurately determine the presence or absence of the food product disposed in the heating chamber.

The present invention is not limited to each of the above-described embodiments. It is possible to make various modifications within the scope of the claims. An embodiment obtained by appropriately combining technical elements each disclosed in different embodiments falls also within the technical scope of the present invention. Further, technical elements disclosed in the respective embodiments may be combined to provide a new technical feature.

### REFERENCE SIGNS LIST

1, 2, 3 Heating cooking apparatus
11 Operation panel
11a Heating change button
12 Front door
13 Heating chamber
13a Top surface
13b Front face opening
13c Flat plate
14 Handle
15 Control frame
16 Device
17 Device substrate
19 Region
20 Guide display
21 Region illumination unit
22 Control unit
22a Determination unit
22b Heating control unit
23 Heating operation unit
24 Result reporting unit
25 Front door opening/closing detection unit
26 Information adjustment unit
31 Light emitting element
32 Light receiving element
32a First light receiving element
32b Second light receiving element
40 Food product
51 Server
52 Memory

1. A heating cooking apparatus, comprising:
a heating chamber;
a reading device configured to read an information code indicating at least a type of food product;
a heating control unit configured to perform heating control of a food product disposed in the heating chamber in accordance with heating information that is necessary for heating cooking and included in the information code read by the reading device; and
a determination unit configured to determine whether a food product is disposed in the heating chamber,
wherein the heating control unit does not perform the heating control when the determination unit determines that no food product is disposed in the heating chamber.

2. The heating cooking apparatus according to claim 1, further comprising:
a light receiving element provided at a position in the heating chamber where light is blocked when the food product is disposed,
wherein the determination unit
determines that no food product is disposed in the heating chamber when a signal indicating that light is received from the light receiving element is received, and
determines that the food product is disposed in the heating chamber when a signal indicating that the light is not received from the light receiving element is received.

3. The heating cooking apparatus according to claim 2, further comprising:
a plurality of the light receiving elements in the heating chamber,
wherein the determination unit
determines that no food product is disposed in the heating chamber by receiving a signal indicating that beams of light from all of the plurality of the light receiving elements are received.

4. The heating cooking apparatus according to claim 1, further comprising:
a light receiving element that is provided in the heating chamber and configured to receive light reflected from the food product when the food product is disposed,
wherein the determination unit
determines that the food product is disposed in the heating chamber when a light reception intensity of light reflected from the light receiving element exceeds a first light reception intensity set in advance, and
determines that no food product is disposed in the heating chamber when the light reception intensity of the light reflected from the light receiving element is equal to or less than the first light reception intensity.

5. The heating cooking apparatus according to claim 4, further comprising:
a plurality of the light receiving elements in the heating chamber,
wherein the determination unit
determines that no food product is disposed in the heating chamber when light reception intensities of beams of light reflected from all of the light receiving elements are equal to or less than the first light reception intensity.
